(19) United States
(12) Patent Application Publication
(10) Pub. No.: US 2008/0003504 A1
(43) Pub. Date: Jan. 3, 2008

(54) POSITIVE ACTIVE MATERIAL FOR RECHARGEABLE LITHIUM BATTERY, METHOD OF PREPARING THE SAME, AND RECHARGEABLE LITHIUM BATTERY INCLUDING THE SAME

(75) Inventors: Jaephil Cho, Yongin-si (KR); Youn-Han Chang, Osan-si (KR); Sang-Hoon Jeon, Daegu-city (KR); Hyun-Jung Lee, Gumi-si (KR)

Correspondence Address: LEXYOUME IP GROUP, LLC, 1233 TWENTIETH STREET, N.W., SUITE 701, WASHINGTON, DC, 20036, US

(73) Assignee: L & F CO., LTD., Daegu-city (KR)

(21) Appl. No.: 11/763,750

(22) Filed: Jun. 15, 2007

(30) Foreign Application Priority Data
Jun. 16, 2006 (KR) 10-2006-0054497

(51) Int. Cl. H01M 4/58; H01M 4/50; H01M 4/52

(52) U.S. Cl. 429/231.95; 252/182.1; 429/231.1; 429/231.3; 429/223; 429/221; 429/224; 429/231.6

(57) ABSTRACT

The present invention relates to a positive active material for a rechargeable lithium battery, a method of preparing the same, and a rechargeable lithium battery including the same. More particularly, the present invention relates to a positive active material for a rechargeable lithium battery including a compound that can reversibly intercalate/deintercalate lithium and a lithium metal phosphate produced through binding with lithium of the compound, the lithium metal phosphate existing from the surface of the compound to a predetermined depth, a method of preparing the positive active material, and a rechargeable lithium battery having the positive active material. The positive active material can accomplish excellent cycle-life characteristic and also, suppress battery swelling at a high temperature.

### CROSS-REFERENCE TO RELATED APPLICATION

This application claims priority to and the benefit of Korean Patent Application No. 10-2006-0054497 filed in the Korean Intellectual Property Office on Jun. 16, 2006, the entire contents of which are incorporated herein by reference.

### BACKGROUND OF THE INVENTION

(a) Field of the Invention

The present invention relates to a positive active material for a rechargeable lithium battery, a method of preparing the same, and a rechargeable lithium battery including the same. More particularly, the present invention relates to a positive active material for a rechargeable lithium battery that can improve cycle-life and swelling inhibition properties at a high voltage, a method of preparing the same, and a rechargeable lithium battery including the same.

(b) Description of the Related Art

In recent times, due to reductions in size and weight of portable electronic equipment, there has been a need to develop batteries for use in the portable electronic equipment, where the batteries have both high performance and large capacity.

Batteries generate electric power by using materials capable of electrochemical reactions at positive and negative electrodes. For example, a rechargeable lithium battery generates electricity due to a change of chemical potential when lithium ions are intercalated/deintercalated at positive and negative electrodes.

The rechargeable lithium battery includes a material that can reversibly intercalate/deintercalate lithium ions as positive and negative active materials. It is fabricated by charging an organic electrolyte solution or a polymer electrolyte solution between the positive and negative electrodes.

In general, a positive active material of a rechargeable lithium battery includes a lithium composite metal compound. For example, LiCoO₂, LiMn₂O₄, LiNiO₂, LiNi₁₋ₓCoₓO₂ (O<x<1), LiMnO₂, and the like have been researched.

Manganese-based positive active materials such as LiMn₂O₄ or LiMnO₂ are the easiest to synthesize, are relatively thermally stable, and are less costly than the other materials, as well as being environmentally friendly. However, these manganese-based materials have relatively low capacity.

LiCoO₂ has good electrical conductivity, high battery voltage, and excellent electrode characteristics. This compound is presently the most commercially available material by Sony Corporation. However, it is relatively expensive and has low stability during charge-discharge at a high rate. LiNiO₂ is currently the least costly of the positive active materials mentioned above and has a high discharge capacity, but it is difficult to synthesize and is the least stable among the above compounds.

LiCoO₂ and LiNiO₂ have excellent electrochemical characteristics as aforementioned. However, in general, they have a limited voltage of 4.3 V and can even be structurally destroyed at 4.5 V, deteriorating capacity. In addition, they can become swollen when allowed to stand at 90° C.

Even a LiCoO₂-based compound can cause thermal runaway due to abrupt loss of oxygen when a battery including the same is overcharged and swollen due to a negative reaction with an electrolyte solution at a high temperature. Accordingly, a conventional attempt to solve this problem has been made by over-adding an additive, such as Al, Mg, or the like, to increase battery safety and thereby minimize swelling of a battery, but this has only a limited effect.

On the other hand, another rechargeable lithium battery has been developed that includes a negative active material such as Si, Sn, SnOx, and the like at a negative electrode, and a Li—Ni—Co-based compound having 15% more capacity than LiCoO₂ at a positive electrode. However, the negative active material is bound with Li, forming an alloy of MₓLi_{y} (M=Si, Sn) and thereby has a negative reaction with an electrolyte solution at a high temperature, resultantly deteriorating cycle-life and causing a swelling problem.

### SUMMARY OF THE INVENTION

An exemplary embodiment of the present invention provides a positive active material for a rechargeable lithium battery that can improve cycle-life characteristic at 4.5 V and reduce swelling due to a negative reaction with an electrolyte solution at a high temperature.

Another embodiment of the present invention provides a method of preparing the positive active material of the present invention.

Yet another embodiment of the present invention provides a rechargeable lithium battery including the positive electrode including the positive active material.

According to an embodiment of the present invention, a positive active material for a rechargeable lithium battery includes a compound that can reversibly intercalate lithium and a lithium metal phosphate produced through binding with lithium of the compound. The lithium metal phosphate exists from the surface of the compound to a predetermined depth thereof.

The compound that can reversibly intercalate/deintercalate lithium may include a lithium composite metal oxide or a lithium chalcogenide.

The lithium composite metal oxide is represented by the following Formula 1.
LiNi_{1-x-y}CoₓM_{y}O₂ [Chemical Formula 1]

Wherein, M is a metal selected from the group consisting of Co, Mn, Mg, Fe, Ni, Al, and combinations thereof, 0≦x≦1, 0≦y≦1, and 0≦x+y≦1.

The lithium metal phosphate is represented by the following Formula 2.
LiMPO₄ [Chemical Formula 2]

Wherein, M is selected from the group consisting of Co, Mn, Ni, Cu, V, Ti, and combinations thereof.

The lithium metal phosphate may exist up to at most 20 nm deep from the surface of the compound that can reversibly intercalate/deintercalate lithium. However, according to another embodiment of the present invention, it may exist up to less than 10 nm from the surface, and according to still another embodiment, it may exist within 0.1 to 5 nm deep.

The lithium metal phosphate may be included in an amount of 0.01 to 2 wt % inside the entire positive active material.

The lithium metal phosphate has an olivine structure.

In addition, the present invention provides a method of preparing a positive active material including preparing a complex compound by injecting and mixing a compound that can reversibly intercalate/deintercalate lithium or its salt, a metal salt, and a phosphate in a solvent, and drying and heat-treating the complex compound.

Furthermore, the present invention provides a method of preparing a positive active material for a rechargeable lithium battery including preparing a complex compound through reaction of a metal salt with a phosphate, mixing the complex compound with a compound that can reversibly intercalate/deintercalate lithium or its salt, and heat-treating the mixture.

Herein, the metal salt may be at least one selected from the group consisting of Co, Mn, Ni, Cu, V, Ti, and combinations thereof.

The phosphate may be at least one selected from the group consisting of monoammonium phosphate (NH₄H₂PO₄), dioammonium phosphate ((NH₄)₂HPO₄), phosphoric acid (H₃PO₄), and combinations thereof.

The salt of the compound that can reversibly intercalate/deintercalate lithium may include at least one salt selected from the group consisting of alkoxide, sulfate, nitrate, acetate, chloride, and phosphate.

The complex compound may be prepared at a temperature ranging from 40 to 50° C.

The drying may be performed at a temperature ranging from 50 to 120° C.

The heat treatment may be performed at a temperature ranging from 400 to 700° C.

In addition, the present invention provides a rechargeable lithium battery including the positive active material.

### BRIEF DESCRIPTION OF THE DRAWINGS

FIG. 1 shows a cross-sectional view of a prismatic rechargeable lithium battery according to the present invention.

FIG. 2A shows a transmission electron microscope photograph of a positive active material of Control Example 1 (100,000 times).

FIG. 2B shows a transmission electron microscope photograph of a positive active material of Control Example 1 (200,000 times).

FIG. 3A shows a transmission electron microscope photograph of a positive active material of Example 1 (100,000 times).

FIG. 3B shows a transmission electron microscope photograph of a positive active material of Example 1 (200,000 times).

FIG. 4 shows a transmission electron microscope photograph of a positive active material of Comparative Example 1 (200,000 times).

FIG. 5 shows cycle-life characteristics of a coin cell of Comparative Example 1.

FIG. 6 shows cycle-life characteristics of a coin cell of Example 3

FIG. 7 shows a graph illustrating thickness change of a coin cell of Example 3 and Comparative Examples 2 and 3 with time.

### DETAILED DESCRIPTION OF THE INVENTION

The present invention provides a positive active material that can improve cycle-life characteristics because a lithium metal phosphate is not coated on a compound but exists from the surface of the compound to deep inside, and also, can reduce swelling due to a negative reaction with an electrolyte solution at a high temperature.

Herein, the positive active material includes a compound that can reversibly intercalate/deintercalate lithium and a lithium metal phosphate produced due to binding with lithium of the compound. Accordingly, it includes a lithium metal phosphate existing up to a predetermined depth from the surface of the compound.

The compound that can reversibly intercalate/deintercalate lithium has no particular limit in the present invention, but may include a lithium composite metal oxide or a lithium chalcogenide compound.

Herein, the lithium composite metal oxide is represented by the following Formula 1.
LiNi_{1-x-y}CoₓM_{y}O₂ [Chemical Formula 1]

Wherein, M is a metal selected from the group consisting of Co, Mn, Mg, Fe, Ni, Al, and combinations thereof, 0≦x≦1, 0≦y≦1, and 0≦x+y≦1.

The lithium metal phosphate is formed due to binding of lithium in a compound that can reversibly intercalate/deintercalate lithium with a metal phosphate. Herein, the metal phosphate is bound with lithium existing in a predetermined depth as well as on the surface of a compound that can reversibly intercalate/deintercalate lithium. A resulting product, LiMPO₄, exists up to at most 20 nm deep from the surface of the compound that can reversibly intercalate/deintercalate lithium. According to another embodiment of the present invention, it may exist less than 10 nm deep or within 0.1 to 5 nm deep.

The lithium metal phosphate has an olivine structure, and also low electrical conductivity, so that it can decrease reactivity of a positive active material with an electrolyte solution, thereby improving cycle-life characteristics and reducing a conventional swelling problem due to a negative reaction of the positive active material with an electrolyte solution at a high temperature.

Accordingly to the embodiment of the present invention, the lithium metal phosphate is represented by the following Formula 2 and has an olivine structure.
LiMPO₄ [Chemical Formula 2]

Wherein, M is selected from the group consisting of Co, Mn, Ni, Cu, V, Ti, and combinations thereof.

The lithium metal phosphate is LiCoPO₄.

Herein, the lithium metal phosphate is included in an amount of 0.01 to 2 wt % in an entire positive active material. If LiMPO₄ is included in an amount of less than this range, it may not improve high temperature characteristics. On the contrary, when it is included in an amount of more than this range, it may deteriorate battery capacity.

According to another embodiment of the present invention, a positive active material may be prepared by either of the following two methods.

### Method A

A positive active material of the present invention is prepared according to a method including preparing a complex compound by injecting and mixing a compound that can reversibly intercalate/deintercalate lithium or its salt, a metal salt, and a phosphate in a solvent; and drying and heat-treating the complex compound.

Hereinafter, each preparation step will be illustrated in more detail.

First of all, a solvent is injected in a reactor, and a compound that can reversibly intercalate/deintercalate lithium or its salt is injected therein. Then, they are uniformly mixed, preparing a complex compound through a co-precipitation reaction between salts.

In other words, the co-precipitation reaction includes a metal salt and a phosphate, and deposits M₃(PO₄)₂ as a complex compound inside the reactor. The deposited M₃(PO₄)₂ reacts with lithium on the surface of the compound that can reversibly intercalate/deintercalate lithium, forming a lithium metal phosphate (LiMPO₄). As a result, the lithium metal phosphate exists on the surface of the compound that can reversibly intercalate/deintercalate lithium and even up to a predetermined depth from the surface.

Herein, the compound that can reversibly intercalate/deintercalate lithium may include a lithium metal oxide and a lithium-containing chalcogenide compound, or at least one salt selected from the group consisting of alkoxide, sulfate, nitrate, acetate, chloride, and phosphate.

The metal salt may include a hydroxide including at least one metal selected from the group consisting of Co, Mn, Ni, Cu, V, Ti, and combinations thereof, oxyhydroxide, nitrate, chloride, carbonate, acetate, oxalate, citrate, and combinations thereof, but is not limited thereto.

Herein, the metal salt may be included in an amount of 0.1 to 5 parts by weight based on 100 parts by weight of the compound that can reversibly intercalate/deintercalate lithium or its salt. When the metal salt is included in an amount of less than this range, a lithium metal phosphate may be formed in a small amount, and thereby, cannot effectively suppress swelling of a battery. On the other hand, when it is included in an amount of more than this range, a lithium metal phosphate with low electrical conductivity excessively exists on the surface of a positive active material, deteriorating C rate-depending characteristics.

The phosphate may be selected from the group consisting of monoammonium phosphate (NH₄H₂PO₄), diammonium phosphate ((NH₄)₂HPO₄), phosphoric acid (H₃PO₄), and combinations thereof.

Herein, the phosphate may be included in an amount of 0.01 to 3 parts by weight based on 100 parts by weight of the compound that can reversibly intercalate/deintercalate lithium or its salt. In one embodiment, the phosphate may be included in an amount of 0.1 to 4 parts by weight based on 100 parts by weight of the compound that can reversibly intercalate/deintercalate lithium or its salt. When the phosphate is included in less than the lower limit, a lithium metal phosphate may be only a little formed, having limited effects. On the contrary, when it is included in more than the upper limit, it may excessively exist or remain as an unreactant, deteriorating battery characteristics.

Herein, a solvent may include a single one or a mixed one selected from the group consisting of water and alcohol, but according to another embodiment of the present invention, it may include water. The alcohol may include a lower alcohol with C1 to C4, selected from the group consisting of methanol, ethanol, isopropanol, and combinations thereof.

This co-precipitation reaction may be performed at a temperature ranging from 40 to 50° C. for 10 to 15 minutes. When the reaction is performed at a temperature of lower than 40° C., the mixture may not be well mixed. On the contrary, when it is performed at a temperature of higher than 50° C., the solvent has a low boiling point, being extremely evaporated. In addition, when the co-precipitation is performed for less than 10 minutes, the mixture may not be well mixed, while when it is performed for more than 15 minutes, the solvent may be excessively evaporated.

Next, a complex compound acquired through the co-precipitation reaction is filtrated, then dried at a temperature ranging from 50 to 120° C. for 5 to 18 hours, and heat-treated at a temperature ranging from 400 to 700° C. for 1 to 15 hours, thereby preparing a positive active material according to the present invention.

Herein, the filtration, drying, and heat treatment are performed with a device that is common in this field, but has no particular limit in the present invention.

### Method B

A positive active material of the present invention can be prepared through preparing a complex compound by reacting a metal salt with a phosphate, and mixing the complex compound with a compound that can reversibly intercalate/deintercalate lithium or its salt and heat-treating the mixture.

The metal salt, the phosphate, and the compound that can reversibly intercalate/deintercalate lithium or its salt are respectively the same as described in method A.

However, the complex compound is mixed with a compound that can reversibly intercalate/deintercalate lithium or its salt, so that a lithium metal phosphate is formed on the surface and inside of the compound that can reversibly intercalate/deintercalate lithium or its salt.

Herein, the complex compound can be dry-mixed with a compound that can reversibly intercalate/deintercalate lithium or its salt. The complex compound should be dried before the mixing.

The drying may be performed at a temperature ranging from 50 to 120° C. for 5 to 18 hours.

The mixture is heat-treated at a temperature ranging from 400 to 700° C. for 1 to 15 hours, preparing a positive active material according to the present invention.

The material prepared through the aforementioned process can be used as a positive active material for a rechargeable lithium battery.

The rechargeable lithium battery includes a positive electrode including a positive active material, a negative electrode including a negative active material, and an electrolyte existing therebetween. Herein, the positive active material may include a lithium composite metal oxide according to the present invention.

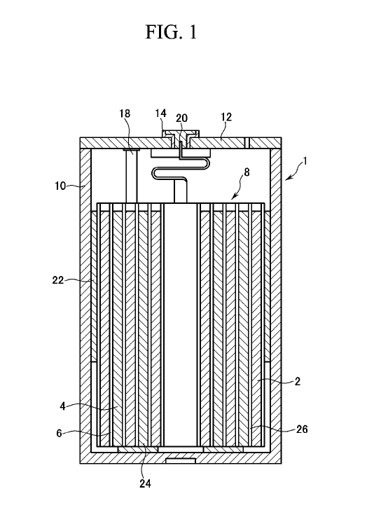

FIG. 1 is a cross-sectional view of a prismatic rechargeable lithium battery according to the embodiment of the present invention. Referring to FIG. 1, a separator 6 is inserted between a positive electrode 2 and a negative electrode 4. They are spiral-wound to form an electrode assembly 8. The electrode assembly 8 is inserted into a case 10. The battery is sealed on top with a cap plate 12 and a gasket 14. The positive electrode 2 and the negative electrode 4 are respectively mounted with a positive tab 18 and a negative tab 20. Insulators 22 and 24 are inserted to prevent an internal short-circuit. Then, an electrolyte is injected before the battery is sealed. The electrolyte 26 impregnates the separator 6. In the drawing, a prismatic rechargeable battery is illustrated but the present invention is not limited thereto and can include any shape as long as it can work as a battery.

The positive electrode may be fabricated by preparing a composition for a positive active material by mixing a positive active material, a conductive agent, a binder, and a solvent, and then coating the composition for a positive active material on the surface of an aluminum current collector. Alternatively, the positive active material composition is cast on a supporter, and then a film peeled off from the supporter can be laminated on an aluminum current collector.

Herein, the conductive agent may include carbon black, graphite, and a metal powder. The binder may include a vinylidenefluoride/hexafluoropropylene copolymer, polyvinylidenefluoride, polyacrylonitrile, polymethylmethacrylate, polytetrafluoroethylene, and a mixture thereof. In addition, the solvent may include N-methylpyrrolidone, acetone, tetrahydrofuran, decane, and the like. Herein, the amount of the positive active material, the conductive agent, the binder, and the solvent may be included in a conventional amount used for a rechargeable lithium battery.

As for the negative electrode, a negative active material, a binder, and a solvent are mixed to prepare a cathode active material composition, like the positive electrode. Then, the cathode active material composition is directly coated on a copper current collector, or is cast on a separate supporter, and then, a film is peeled off from the supporter and laminated on a copper current collector. Herein, a conductive agent can be further added to the negative active material composition if it is needed.

The negative active material may include a material that can intercalate/deintercalate lithium, for example, a lithium metal or a lithium alloy, coke, artificial graphite, natural graphite, a combusted organic polymer compound carbon fiber, and the like. In addition, the conductive agent, the binder, and the solvent can be used the same as with the positive electrode.

The separator can include any one that can be conventionally used in a rechargeable lithium battery, for example, polyethylene, polypropylene, polyvinylidene fluoride, or a multilayer thereof. In addition, it may include a mixed layer such as double-layer polyethylene/polypropylene separator, a triple-layer polyethylene/polypropylene/polyethylene separator, and a triple-layer polypropylene/polyethylene/polypropylene separator.

The electrolyte filled in the rechargeable lithium battery may include a non-aqueous electrolyte or a conventional solid electrolyte in which a lithium salt is dissolved.

The solvent of the non-aqueous electrolyte may include, but is not limited to, a cyclic carbonate such as ethylene carbonate, propylene carbonate, butylenes carbonate, vinylene carbonate, and the like; a linear carbonate such as dimethyl carbonate, methylethyl carbonate, diethyl carbonate, and the like; an ester such as methyl acetate, ethyl acetate, propyl acetate, methyl propionate, ethyl propionate, γ-butyrolactone, and the like; an ether such as 1,2-dimethoxyethane, 1,2-diethoxyethane, tetrahydrofuran, 1,2-dioxane, 2-methyltetrahydrofuran, and the like; a nitrile such as acetonitrile and the like; and an amide such as dimethylformamide and the like. These can be used singluraly or in combinations. In particular, a mixed solvent of cyclic carbonate and linear carbonate can be used.

In addition, the electrolyte may include a gel-type polymer electrolyte prepared by impregnating an electrolyte solution in a polymer electrolyte such as polyethyleneoxide, polyacrylonitrile, and the like, or an inorganic solid electrolyte such as LiI, Li₃N, and the like.

Herein, the lithium salt may be selected from the group consisting of LiPF₆, LiBF₄, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiCl, and LiI.

Unlike a rechargeable lithium battery including a conventional positive active material such as a lithium composite metal oxide or a lithium chalcogenide compound, a rechargeable lithium battery including the positive active material of the present invention can have excellent electrochemical characteristics at 4.5 V, thereby improving cycle-life and decreasing a negative reaction with an electrolyte solution at a high temperature, suppressing battery swelling.

The following examples illustrate the present invention in more detail. However, the following examples are only exemplary embodiments of the present invention, and the present invention is not limited thereto.

### EXAMPLES

### Positive Active Material

### Example 1

30 g of water was poured in a reactor and set at 45° C., and then 100 g of LiCoO₂ powder, 1 g of Co(NO₃).H₂O, and 0.36 g of (NH₄)₂HPO₄ were injected thereto. Then, they were uniformly mixed for 3 hours. While they were mixed, a complex compound was precipitated at the bottom of the reactor.

The complex compound was filtrated, then dried at 100° C. for 3 hours, and heat-treated at 700° C. for 5 hours, preparing a positive active material in which LiCoPO₄ existed on the surface of LiCoO₂ and up to deep inside thereof. Herein, LiCoPO₄ was included in the entire positive active material in an amount of 1 wt % and existed up to an average 5 nm deep from the surface.

### Example 2

A complex compound was prepared by pouring 30 g of water in a reactor and setting at 45° C., and then injecting 100 g of LiNi_{0.85}Co_{0.1}Al_{0.05} powder, 1 g of Mn(NO₃).H₂O, and 0.36 g of (NH₄)₂HPO₄ therein. Then, they were uniformly mixed for 3 hours.

The complex compound was gained through filtration, dried at 100° C. for 3 hours, and heat-treated at 700° C. for 7 hours, preparing a positive active material in which LiCoPO₄ existed on the surface of LiNi_{0.85}Co_{0.1}Al_{0.05} and into deep inside thereof. Herein, LiMnPO₄ was included in the entire positive active material in an amount of 1 wt % up to an average 6 nm deep from the surface.

### Comparative Example 1

A complex compound was prepared by pouring 30 g of water in a reactor and setting at 45° C., and then injecting 100 g of LiNi_{0.85}Co_{0.1}Al_{0.05} powder, 1 g of Mn(NO₃).H₂O, and 0.36 g of (NH₄)₂HPO₄ therein. Then, they were uniformly mixed for 3 hours.

The complex compound was gained through filtration, dried at 100° C. for 3 hours, and heat-treated at 700° C. for 7 hours, preparing a LiCoO₂ positive active material coated with AlPO₄. Herein, AlPO₄ was included in the entire positive active material in an amount of 1 wt %, and was coated to be an average 20 nm thick on the surface of LiCoO₂ but did not exist inside of LiCoO₂.

### Comparative Example 2

A positive active material was prepared as disclosed in Korean Patent No. 10-2004-771591.

100 ml of water was poured into a reactor, and 1 g of (NH₄)₂HPO₄ and 1.5 g of Al(NO₃)₃.9H₂O were added thereto, preparing a coating liquid. Herein, an amorphous AlPO₄ phase was deposited as a colloid shape.

10 ml of the coating liquid was mixed with 20 g of LiCoO₂. The resulting product was dried at 130° C. for 30 minutes and heat-treated at 400° C. for 5 hours, preparing a LiCoO₂ positive active material coated with AlPO₄. Herein, AlPO₄ was included in the entire positive active material in an amount of 1 wt %, and coated to be an average 25 nm thick on the surface of LiCoO₂ but did not exist inside LiCoO₂.

### Experimental Example 1

The positive active materials according to Example 1 and Comparative Example 1 were observed with a transmission electron microscope (TEM) regarding their particle characteristics. Herein, LiCoO₂ powder was used as Control Example 1.

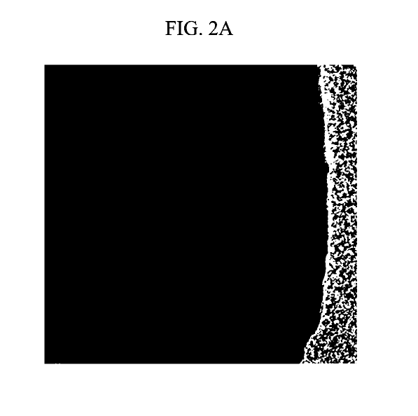

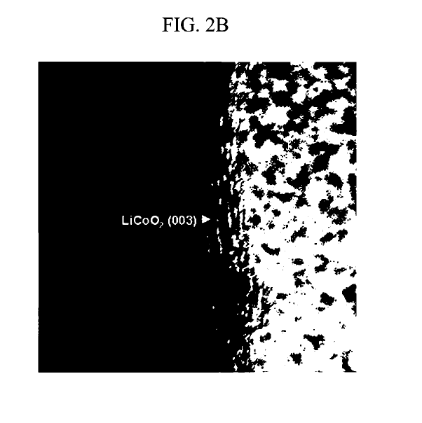

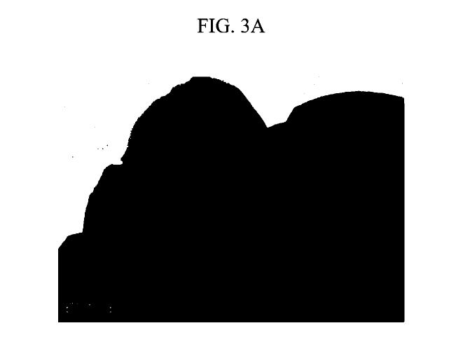

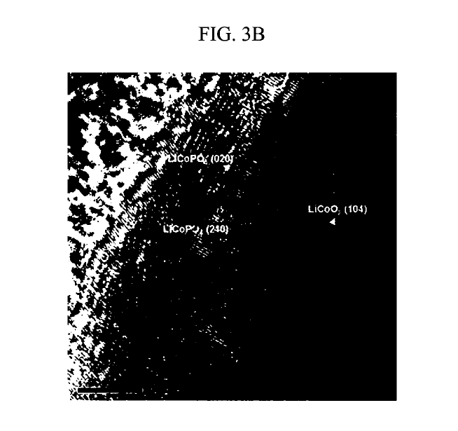

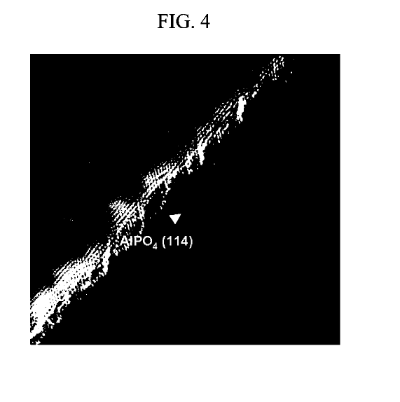

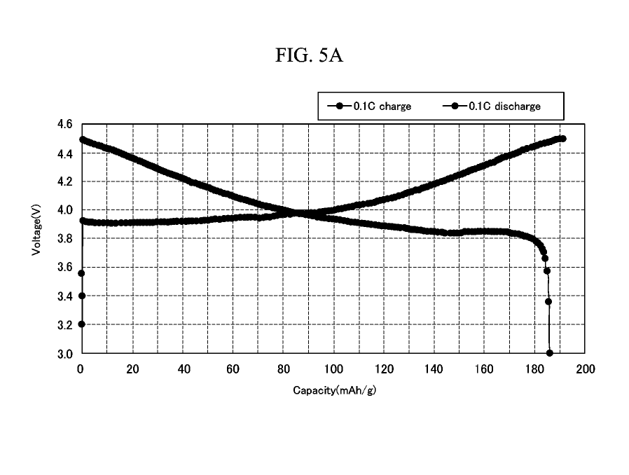

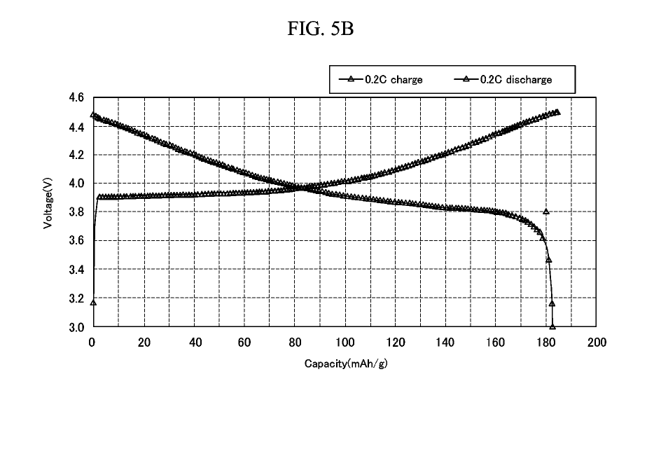

FIGS. 2A and 2B show transmission electron microscope photographs of the positive active material (LiCoO₂) according to Control Example 1 (150,000 times), while FIGS. 3A and 3B show transmission electron microscope photographs of the positive active material (LiCoPO₄—LiCoO₂) according to Example 1 (150,000 times). FIG. 4 shows a transmission electron microscope photograph of the positive active material (AlPO₄—LiCoO₂) according to Comparative Example 1 (200,000 times).

Referring to FIGS. 2A and 3A, a LiCoPO₄—LiCoO₂ positive active material of Example 1 turned out to have an increased particle size compared with the LiCoO₂ positive active material of Control Example 1. In addition, referring to the enlarged photographs of FIGS. 3A and 3B, the positive active material of Example 1 of the present invention included both LiCoO₂ and LiCoPO₄. This result does not indicate that Co₃(PO₄)₂ produced during the process was formed on the surface of LiCoO₂ but that Co₃(PO₄)₂ reacted with the Li of LiCoO₂, forming LiCoPO_{4.}

On the contrary, referring to FIG. 4, the positive active material of Comparative Example 1 included an AlPO₄ layer coated on the surface of LiCoO_{2.}

### Half Cell

### Example 3

The positive active material of Example 1 was used to fabricate a coin-type cell.

The positive active material of Example 1, super-P as a conductive agent, and polyvinylidene fluoride as a binder were mixed in a weight ratio of 96/2/2, preparing a composition for a positive electrode. The composition for a positive electrode was coated to be 300 μm thick on an Al-foil, and then dried at 130° C. for 20 minutes. Then, it was pressed with a pressure of 1 ton, preparing a positive electrode substrate.

The positive electrode substrate and a lithium metal as a counter electrode were used to fabricate a coin-type cell. Herein, an electrolyte was prepared by mixing ethylene carbonate (EC) and dimethyl carbonate (DMC) in a volume ratio of 1:1 to prepare a solvent, and then dissolving 1M of LiPF₆ therein.

### Example 4

In addition, the positive active material of Example 2 was used to fabricate a coin-type cell.

The positive active material of Example 2, super-P as a conductive agent, and polyvinylidene fluoride as a binder were mixed in a weight ratio of 94/3/3, preparing a composition for a positive electrode. The composition for a positive electrode was coated to be 300 μm thick on an Al-foil, and then dried at 130° C. for 20 minutes. Then, it was pressed with a pressure of 1 ton, preparing a positive electrode substrate.

The positive electrode substrate and a lithium metal as a counter electrode were used to fabricate a coin-type cell. Herein, an electrolyte was prepared by mixing ethylene carbonate (EC) and dimethyl carbonate (DMC) in a volume ratio of 1:1 to prepare a solvent, and then dissolving 1M of LiPF₆ therein.

### Comparative Example 2

A coin-type cell was fabricated according to the same method as in Example 3 except for using a positive active material of Comparative Example 1, in which LiCoO₂ was coated with AlPO_{4.}

### Comparative Example 3

A coin-type cell was fabricated according to the same method as in Example 3 except for using LiCoO₂ powder as a positive active material.

### Experimental Example 2: Cell Characteristics

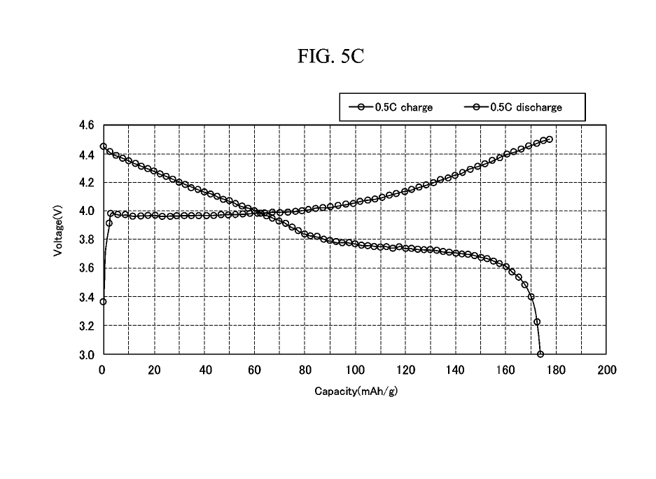

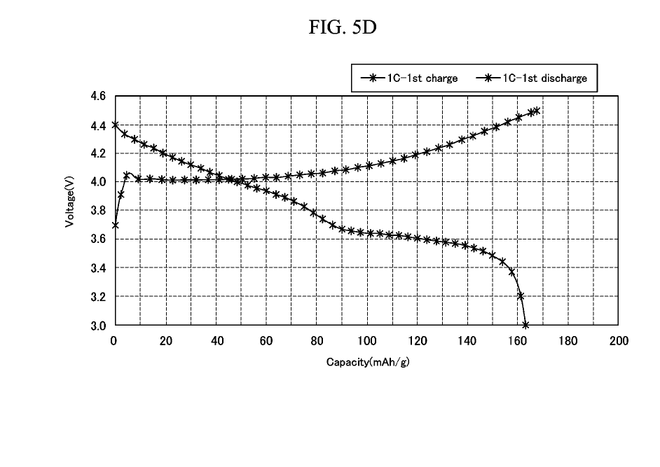

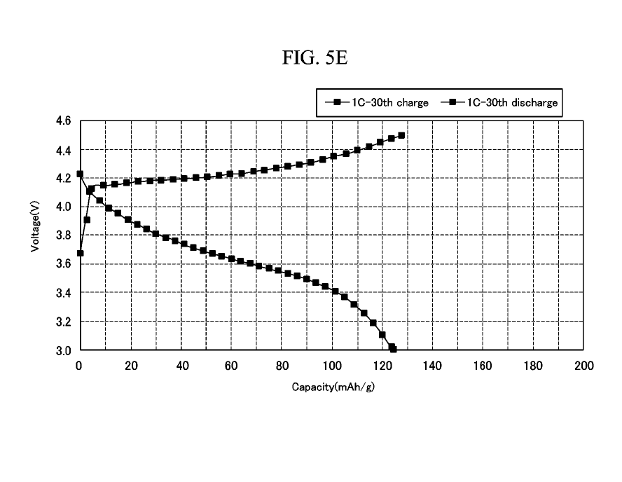

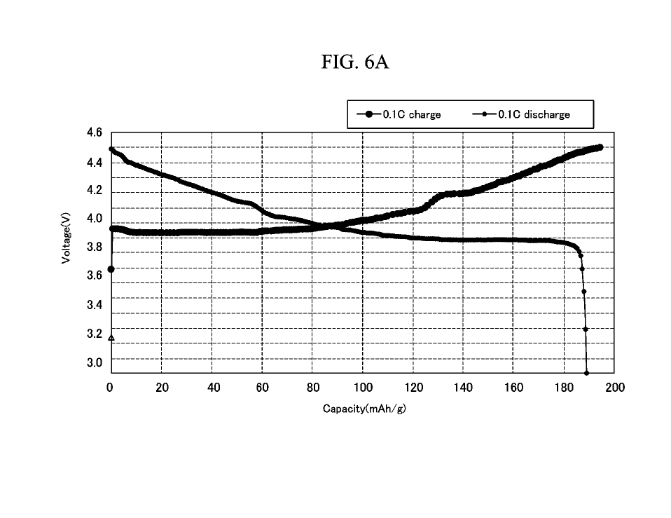

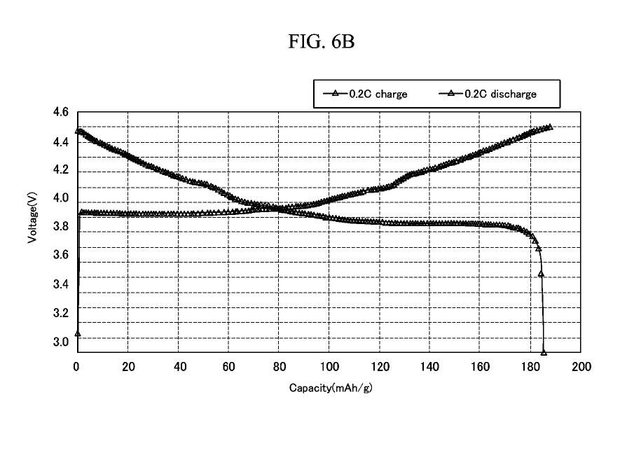

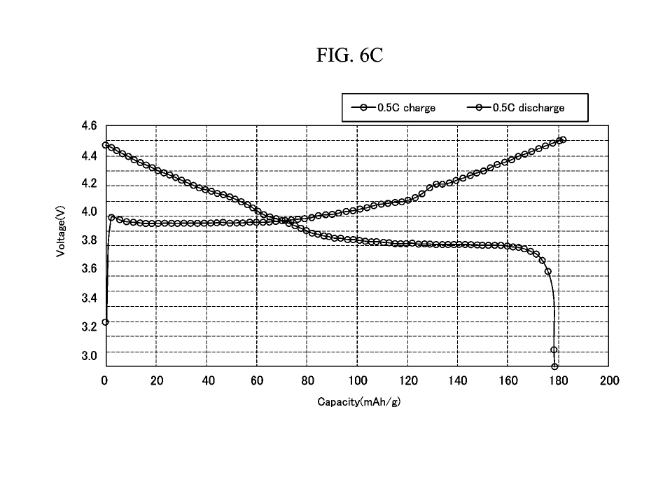

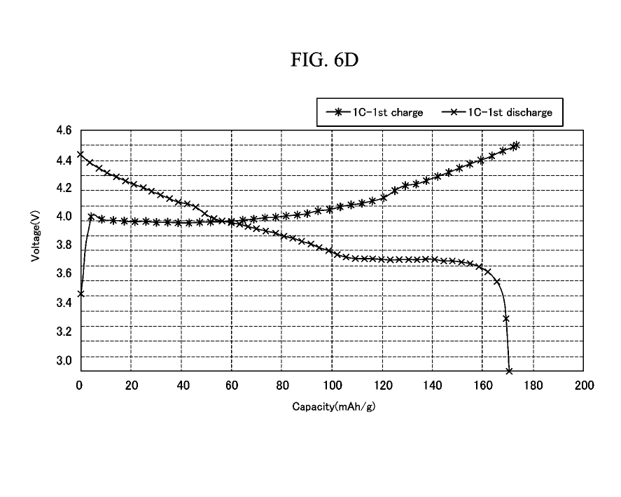

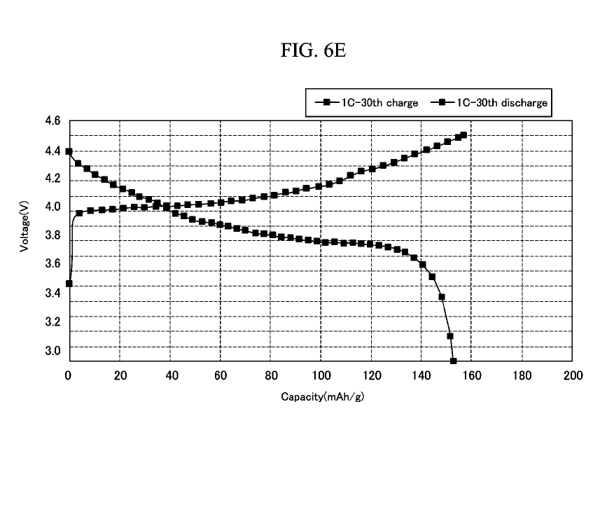

Cycle-life characteristics were examined with regards to whether LiCoPO₄ was included in the positive active material, as follows. The coin cells of Example 3 and Comparative Example 3 were examined regarding charge and discharge within a voltage range of 3.0 to 4.5 V with a charge and discharge device at room temperature (30° C.). The results are provided in the following Tables 1 and 2 and FIGS. 5 and 6.

FIG. 5 shows the charge and discharge graph of the coin cell of Comparative Example 3 within a voltage range of 3.0 to 4.5 V, while FIG. 6 shows the charge and discharge graph of the coin cell of Example 3 within a voltage range of 3.0 to 4.5 V. The following Tables 1 and 2 show discharge capacity and discharge voltage according to a C-rate based on FIGS. 5 and 6.

### 1) Cycle-Life Characteristics

The following Table 1 shows discharge capacity according to C-rate.

TABLE 1

| | | | | 1 C (first | 1 C (30th |
|---|---|---|---|---|---|
| | 0.1 C | 0.2 C | 0.5 C | discharge) | discharge) |
| Example 3 | 190 mAh/g | 186 mAh/g | 179 mAh/g | 176 mAh/g | 153 mAh/g |
| Comparative | 186 mAh/g | 182 mAh/g | 173 mAh/g | 163 mAh/g | 124 mAh/g |
| Example 3 | | | | | |

Referring to FIG. 5 and Table 1, the coin cell of Comparative Example 3 had an initial discharge capacity of 186 mA/g at 0.1 C and an initial discharge capacity of 163 mAh/g at 1 C. Accordingly, the initial discharge capacity decreased as the charge and discharge current (C-rate) increased. In addition, after it was 30 times cycled at 1 C, the initial discharge capacity decreased from 163 to 124 mAh/g.

On the contrary, referring to Table 1 and FIG. 6, although the coin cell of Example 3 had an initial discharge capacity that decreased from 190 mAh/g at 0.1 C to 176 mAh/g at 1 C as the charge and discharge current (C-rate) increased, its decrease was not as big as that of Comparative Example 3. In addition, after 30 cycles at 1 C, it had an initial discharge capacity that decreased from 176 to 153 mAh/g, but again, the decrease was not as big as that of Comparative Example 3. As a result, the coin cell of Example 3 turned out to have about 20% increased initial discharge capacity at 1 C compared with the coin cell of Comparative Example 3.

### 2) Cycle-Life Characteristics

The following Table 2 shows discharge voltage according to C-rate.

TABLE 2

| | | | | 1 C (1st | 1 C (30^{th} |
|---|---|---|---|---|---|
| | 0.1 C | 0.2 C | 0.5 C | discharge) | discharge) |
| Example 3 | 4.48 V | 4.48 V | 4.47 V | 4.45 V | 4.40 V |
| Comparative | 4.48 V | 4.46 V | 4.45 V | 4.40 V | 4.23 V |
| Example 3 | | | | | |

Referring to Table 2, the coin cell of Example 3 shows about 0.2V higher discharge voltage than that of Comparative Example 3 after 30 charge and discharge cycles, indicating that the coin cell of Example 3 experiences less overvoltage than that of Comparative Example 3. These results are caused by the lithium metal phosphate, LiCoPO₄, that exists on the surface and internally of the positive active material according to Example 3.

### Experimental Example 3: Characteristics of Swelling Suppression

Battery swelling was examined with regards to whether the positive active material included LiCoPO₄, as follows.

The coin cells of Example 3 and Comparative Examples 2 and 3 were charged with 4.5 V at a room temperature of 30° C. by using a charge and discharge device, and then allowed to stand at 90° C. for 12 hours. The thickness of electrodes was measured with a micrometer. Herein, the coin cells had a thickness of 4.6 mm, and the thickness was measured at 90° C. every 2 hours.

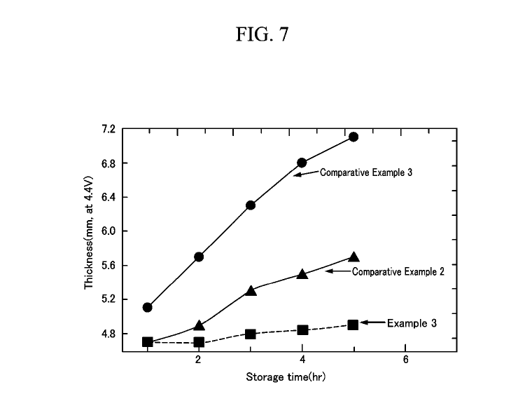

FIG. 7 shows thickness change of the coin cells according to Example 3 and Comparative Examples 2 and 3 with time. The results are shown in Table 3.

TABLE 3

| | 0 hr | 2 hr | 3 hr | 4 hr | | 5 hr |
|---|---|---|---|---|---|---|
| Example 3 | 4.7 mm | 4.7 mm | 4.8 mm | 4.85 | mm | 4.9 mm |
| Comparative | 4.7 mm | 4.9 mm | 5.3 mm | 5.5 | mm | 5.7 mm |
| Example 2 | | | | | | |
| Comparative | 5.1 mm | 5.7 mm | 6.3 mm | 6.8 | mm | 7.1 mm |
| Example 3 | | | | | | |

Referring to Table 3, the coin cell of Example 3 had a thickness of 4.7 mm right after the charge and a thickness of 4.9 mm 5 hours later, showing 0.2 mm thickness increase and having a thickness variation ratio of less than 5%.

On the contrary, the coin cell of Comparative Example 2 including a positive active material coated with AlPO₄ had 1.0 mm increased thickness from 4.7 to 5.7 mm 5 hours later. In addition, the coin cell of Comparative Example 3 including LiCoO₂ as a positive active material had a thickness of 5.1 mm right after the charge but a thickness of 6.3 mm 3 hours later, showing 23% increased thickness and also, a thickness of 7.1 mm 5 hours later. In brief, when LiCoO₂ was used as a single positive active material, a coin cell had severe swelling. Even when a positive active material was coated with AlPO₄ on the surface, the coating had very little effect.

However, when a positive active material including LiCoPO₄ was included, it can strongly suppress swelling of a coin cell. The LiCoPO₄ had low conductivity, suppressing a negative reaction with an electrolyte solution and preventing elution of Co.

Therefore, the present invention provides a positive active material in which LiCoPO₄ exists on the surface of and inside a compound that can reversibly intercalate/deintercalate lithium. The positive active material can improve cycle-life characteristics of a rechargeable lithium battery when it is included at a positive electrode and can effectively suppress swelling due to a negative reaction with an electrolyte solution at a high temperature.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A positive active material for a rechargeable lithium battery comprising:
a compound that can reversibly intercalate/deintercalate lithium; and
a lithium metal phosphate produced through binding with lithium of the compound, wherein
the lithium metal phosphate exists from the surface of the compound up to a predetermined depth.

2. The positive active material of claim 1, wherein the compound that can reversibly intercalate/deintercalate lithium includes a lithium composite metal oxide or a lithium chalcogenide.

3. The positive active material of claim 2, wherein the lithium composite metal oxide is represented by the following Formula 1:
LiNi_{1-x-y}CoₓM_{y}O₂ [Chemical Formula 1]
wherein, M is a metal selected from the group consisting of Co, Mn, Mg, Fe, Ni, Al, and combinations thereof, 0≦x≦1, 0≦y<1, and 0≦x+y≦1.

4. The positive active material of claim 1, wherein the lithium metal phosphate is represented by the following Formula 2:
LiMPO4 [Chemical Formula 2]
wherein, M is selected from the group consisting of Co, Mn, Ni, Cu, V, Ti, and combinations thereof.

5. The positive active material of claim 1, wherein the lithium metal phosphate exists from the surface of the compound that can reversibly intercalate/deintercalate lithium up to at most 20 nm deep.

6. The positive active material of claim 1, wherein the lithium metal phosphate exists from the surface of the compound that can reversibly intercalate/deintercalate lithium up to less than 10 nm deep.

7. The positive active material of claim 1, wherein the lithium metal phosphate exists from the surface of the compound that can reversibly intercalate/deintercalate lithium up to 0.1 to 5 nm deep.

8. The positive active material of claim 1, wherein the lithium metal phosphate is included in an amount of 0.01 to 2 wt % of the entire positive active material.

9. The positive active material of claim 1, wherein the lithium metal phosphate has an olivine structure.

10. A method of preparing a positive active material for a rechargeable lithium battery comprising:
preparing a complex compound by injecting a compound that can reversibly intercalate/deintercalate lithium or its salt, a metal salt, and a phosphate, in a solvent and then mixing them; and
drying and heat-treating the complex compound.

11. The method of claim 10, wherein the compound that can reversibly intercalate/deintercalate lithium is a lithium metal oxide or a lithium-containing chalcogenide compound.

12. The method of claim 11, wherein the lithium composite metal oxide is represented by the following Formula 1:
LiNi_{1-x-y}CoₓM_{y}O₂ [Chemical Formula 1]
wherein, M is a metal selected from the group consisting of Co, Mn, Mg, Fe, Ni, Al, and combinations thereof, 0≦x≦1, 0≦y≦1, and 0≦x+y≦1.

13. The method of claim 10, wherein the compound that can reversibly intercalate/deintercalate lithium includes one salt selected from the group consisting of alkoxide, sulfate, nitrate, acetate, chloride, and phosphate.

14. The method of claim 10, wherein the metal salt is selected from the group consisting of nitrate, chloride, sulfate, carbonate, acetate, and combinations thereof that comprises a metal selected from the group consisting of Co, Mn, Ni, Cu, V, Ti, and combinations thereof.

15. The method of claim 10, wherein the phosphate is selected from the group consisting of monoammonium phosphate (NH₄H₂PO₄), diammonium phosphate ((NH₄)₂HPO₄), phosphoric acid (H₃PO₄), and combinations thereof.

16. The method of claim 10, wherein the solvent is selected from the group consisting of water, alcohol, and a combination thereof.

17. The method of claim 10, wherein the complex compound is prepared at a temperature ranging from 40 to 50° C.

18. The method of claim 10, wherein the drying is performed at a temperature ranging from 50 to 120° C.

19. The method of claim 10, wherein the heat treatment is performed at a temperature ranging from 400 to 700° C.

20. A method of preparing a positive active material for a rechargeable lithium battery comprising:
preparing a complex compound through reaction of a metal salt with a phosphate; and
mixing the complex compound with a compound that can reversibly intercalate/deintercalate lithium or its salt, and then heat-treating the resulting mixture.

21. The method of claim 20, wherein the compound that can reversibly intercalate/deintercalate lithium is a lithium metal oxide or a lithium-containing chalcogenide compound.

22. The method of claim 21, wherein the lithium composite metal oxide is represented by the following Formula 1:
LiNi_{1-x-y}CoₓM_{y}O₂ [Chemical Formula 1]
wherein, M is a metal selected from the group consisting of Co, Mn, Mg, Fe, Ni, Al, and combinations thereof, 0≦x≦1, 0≦y≦1, and 0≦x+y≦1.

23. The method of claim 20, wherein the salt of the compound that can reversibly intercalate/deintercalate lithium is selected from the group consisting of alkoxide, sulfate, nitrate, acetate, chloride, and phosphate.

24. The method of claim 20, wherein the metal salt is selected from the group consisting of nitrate, chloride, sulfate, carbonate, acetate, and combinations thereof that comprises a metal selected from the group consisting of Co, Mn, Ni, Cu, V, Ti, and combinations thereof.

25. The method of claim 20, wherein the phosphate is selected from the group consisting of monoammonium phosphate (NH₄H₂PO₄), diammonium phosphate ((NH₄)₂, phosphoric acid (H₃PO₄), and combinations thereof.

26. The method of claim 20, wherein the solvent is selected from the group consisting of water, alcohol, and a combination thereof.

27. The method of claim 20, wherein the complex compound is prepared at a temperature ranging from 40 to 50° C.

28. The method of claim 20, wherein the complex compound is dry-mixed with a compound that can reversibly intercalate/deintercalate lithium or its salt.

29. The method of claim 20, wherein the complex compound is dried first before mixing.

30. The method of claim 20, wherein the drying is performed at a temperature ranging from 50 to 120° C.

31. The method of claim 20, wherein the heat treatment is performed at a temperature ranging from 400 to 700° C.

32. A rechargeable lithium battery comprising:
a positive electrode comprising a positive active material;
a negative electrode comprising a negative active material; and
an electrolyte existing between the positive and negative electrodes,
wherein the positive active material comprises
a compound that can reversibly intercalate/deintercalate lithium, and
a lithium metal phosphate produced through binding with lithium of the compound, and wherein
the lithium metal phosphate exists from the surface of the compound to a predetermined depth.
